(19) United States
(12) Patent Application Publication
(10) Pub. No.: US 2024/0155575 A1
(43) Pub. Date: May 9, 2024

(54) METHODS AND SYSTEMS FOR COVERAGE ENHANCEMENT IN WIRELESS NETWORKS

(71) Applicant: ZTE Corporation, Shenzhen (CN)

(72) Inventors: Yiwei DENG, Shenzhen (CN); Xianghui HAN, Shenzhen (CN); Chunli LIANG, Shenzhen (CN); Peng HAO, Shenzhen (CN); Jian LI, Shenzhen (CN); Wei GOU, Shenzhen (CN)

(21) Appl. No.: 18/533,139

(22) Filed: Dec. 7, 2023

Related U.S. Application Data
(63) Continuation of application No. PCT/CN2021/110935, filed on Aug. 5, 2021.

(51) Int. Cl. H04W 72/0446; H04L 1/00; H04W 72/231; H04W 76/20

(52) U.S. Cl. CPC H04W 72/0446; H04L 1/0067; H04W 72/231; H04W 76/20

(57) ABSTRACT

Apparatuses, methods, and systems for a transport block (TB) processing over multiple slots (TBoMS) that can accomplish coverage enhancement are disclosed. In one aspect, the method includes configuring, by a communication node, a time domain resource assignment list that indicates a number of single slot repetitions for a single slot repetition transmission and a number of slots allocated for transport block processing over multiple slots, and transmitting a message based on the time domain resource assignment list.

### CROSS-REFERENCE TO RELATED APPLICATIONS

This application is a continuation of International Patent Application No. PCT/CN2021/110935, filed on Aug. 5, 2021, the contents of which are incorporated herein by reference in their entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

This patent document describes, among other things, techniques for a transport block (TB) processing over multiple slots (TBoMS) that can accomplish coverage enhancement.

In one aspect, a method of data communication is disclosed. The method includes configuring, by a communication node, a time domain resource assignment list that indicates a number of single slot repetitions for a single slot repetition transmission and a number of slots allocated for transport block processing over multiple slots, and transmitting a message based on the time domain resource assignment list.

In another aspect, a method of data communication is disclosed. The method includes configuring, by a communication node, a time domain pattern for transport block processing over multiple slots, wherein the time domain pattern for transport block processing over multiple slots (TBoMS) is based on a TBoMS transmission occasion, and wherein a structure of TBoMS transmission occasion includes one slot or multiple consecutive physical slots.

In another aspect, a method of data communication is disclosed. The method includes determining, by a communication node, one or more redundancy versions for transmission occasions for transport block processing over multiple slots; and performing the transport block processing over multiple slots based on a cycling sequence of the one or more redundancy versions.

In another aspect, a method of data communication is disclosed. The method includes multiplexing, by a wireless device, on a physical uplink shared channel, uplink control information that is carried on a physical uplink shared channel; and transmitting the multiplexed uplink control information based on a first timeline.

In another aspect, a method of data communication is disclosed. The method includes determining, by a wireless device, a physical uplink shared channel transmission power in a physical uplink shared channel transmission occasion when the wireless device transmits a physical uplink shared channel on an active uplink bandwidth part of a carrier of a serving cell; and performing a transport block processing over multiple slots based on the determined physical uplink shared channel transmission power.

In another aspect, a method of data communication is disclosed. The method includes configuring a plurality of hybrid automatic repeat request (HARQ) feedback occasions for a physical downlink shared channel (PDSCH) transmission; and performing a transmission of hybrid automatic repeat request acknowledgement (HARQ-ACK) for PDSCH on the feedback occasions.

In another aspect, a method of data communication is disclosed. The method includes configuring, by a communication node, a plurality of timelines and physical uplink control channel (PUCCH) resources for a wireless device to feed back a hybrid automatic repeat request acknowledgement (HARQ-ACK) of a physical downlink shared channel (PDSCH) transmission.

In another example aspect, a wireless communication apparatus comprising a processor configured to implement an above-described method is disclosed.

In another example aspect, a computer storage medium having code for implementing an above-described method stored thereon is disclosed.

These, and other, aspects are described in the present document.

### BRIEF DESCRIPTION OF THE DRAWING

FIG. 1 shows an example of transmission block processing over multiple-slots (TBoMS) time domain pattern based on a fixed indication length TOT (transmission occasion of TBoMS).

FIG. 2 shows an example of TBoMS time domain pattern based on a flexible length of TOT.

FIG. 3 shows an example of TBoMS time domain pattern based on flexible length of TOT.

FIG. 4 shows an example of TBoMS time domain pattern is based on the length of first TOT.

FIG. 5 shows an example of multiple redundancy version (RV) cycling in TOTs.

FIG. 6 shows new rules for RV cycling in TOTs.

FIG. 7 shows an example of bits mapping for TOTs.

FIG. 8 shows an example where a feedback occasion is configured based on TOT.

FIG. 9 shows an example where a feedback occasion is configured based on code block group (CBG).

FIG. 10 shows feedback hybrid automatic repeat request acknowledgement (HARQ-ACK) bits based on CBG.

FIG. 11 shows an example of HARQ-ACK feedback occasions based on a first TOT.

FIG. 12 shows an example of a wireless communication method based on some embodiments of the disclosed technology.

FIG. 13 shows another example of a wireless communication method based on some embodiments of the disclosed technology.

FIG. 14 shows another example of a wireless communication method based on some embodiments of the disclosed technology.

FIG. 15 shows another example of a wireless communication method based on some embodiments of the disclosed technology.

FIG. 16 shows another example of a wireless communication method based on some embodiments of the disclosed technology.

FIG. 17 shows another example of a wireless communication method based on some embodiments of the disclosed technology.

FIG. 18 shows another example of a wireless communication method based on some embodiments of the disclosed technology.

FIG. 19 shows an example of a wireless communication system.

FIG. 20 is a block diagram representation of a portion of a radio station based on one or more embodiments of the disclosed technology can be applied.

### DETAILED DESCRIPTION

Section headings are used in the present document only for ease of understanding and do not limit scope of the embodiments to the section in which they are described. Furthermore, while embodiments are described with reference to 5G examples, the disclosed techniques may be applied to wireless systems that use protocols other than 5G or 3GPP protocols.

In the RAN plenary #90 e-meeting, a new WID on New Radio (NR) coverage enhancement was approved. The objective of this work item is to solve the problem of the coverage bottleneck channels. A physical uplink share channel (PUSCH) is potential coverage bottleneck channel. The disclosed technology can be implemented in some embodiments to provide enhancement mechanisms for PUSCH.

Coverage is one of the key factors that an operator considers when commercializing cellular communication networks due to its direct impact on service quality as well as CAPEX and OPEX. Despite the importance of coverage on the success of NR commercialization, a thorough coverage evaluation and a comparison with legacy RATs considering all NR specification details have not been done up to now.

Among physical channels, PUSCH is a potential coverage bottleneck channel. For PUSCH transmission, transport block (TB) processing over multiple slots (TBoMS) is proposed as a way for coverage enhancement. The disclosed technology can be implemented in some embodiments to determine the number of slots, time domain pattern and UCI (uplink control information) multiplexing on PUSCH for TB processing over multiple slots, such as the location, timeline or coded modulation symbols determination for UCI multiplexing on TBoMS PUSCH.

### Embodiment 1

When TB processing over multiple slots (TBoMS) is enabled, the number of slots for TBoMS is indicated based on some implementations of the disclosed technology. In 3GPP RAN1 #105 e-meeting, it's has been agreed that the number of slots allocated for TBoMS is determined by using a row index of time domain resource assignment (TDRA) list. The disclosed technology can be implemented in some embodiments to indicate the number of slots as will be discussed below.

Method 1: Single slot repetition and TBoMS transmission use the same TDRA table and a new column is added into the TDRA list or table to indicate the number of slots for TBoMS.

For instance, as show in Table 1 below, a new information element (IE) is added to the TDRA list to indicate the number of slots for TBoMS (denoted as M in Table 1), where the value of M is equal to or larger than 1. In some embodiments, the numberOfRepetitions and the number of slots for TBoMS should not be larger than 1 simultaneously within a same index. Whether the TBoMS transmission is enabled or not is based on value of the number of slots. For example, the value of the number of slots that is larger than 1 can indicate that TBoMS transmission is enabled. Similarly, for a single slot repetition transmission, when the value of the numberOfRepetitions is larger than 1, that value can indicate TBoMS transmission is disabled and a single slot repetition transmission is enabled. In some embodiments, the value of the numberOfRepetitions and number of slots can be configured independently with no limitations (e.g., both values can be larger than 1) and RRC or MAC CE signaling is used to indicate which feature is enabled, Here, the feature indicates a single slot repetition transmission or TBoMS transmission. For example, when TBoMS transmission is enabled, UE will omit the numberOfRepetitions, and when TBoMS transmission is not enabled, UE will omit the number of slots. In some embodiments, 1 bit in DCI (e.g., reuse 1 bit within FDRA field) is used to indicate which IE in the TDRA list should be enabled, for instance, “0” indicates the “numberOfRepetitions” feature is enabled, and “1” indicates the “number of slots” feature is enabled. In some embodiments, an RRC, MAC CE and a field in DCI can be indicated using at least 3 states. For example, one of the states (e.g., indicated by “00”) indicates a single slot repetition feature is enabled, which means the numberOfRepetitions column is available. One of the states (e.g., indicated by “01”) indicates TBoMS transmission without repetition is enabled, which means the number of slots column is available, and one of the state (e.g. indicated by “11 or 10”) indicates TBoMS transmission with repetitions is enabled, which means both the numberOfRepetitions and number of slots are available. In some embodiments, the number of slots for TBoMS is available slots or physical slots. In this case, a signaling to indicate the type of slots will be needed, such as RRC, MAC-CE, or DCI. In some embodiments, the slot type (available slots or physical slots) for TBoMS transmission is identical to the slot type for single slot repetition transmission. When the number of slots for single slot repetition transmission is counted based on available slots, the number of slots for TBoMS transmission is also based on available slots, and when the number slots for single slot repetition transmission is counted based on physical slots, then the number of slots for TBoMS is also based on physical slots. In some embodiments, the value of the numberOfRepetitions and number of slots for TBoMS can be configured independently with no limitations (e.g., both values can be larger than 1). It means the repetition of TBoMS is enabled when both of the values within a same index are larger than 1. Furthermore, it means the TBoMS without repetition is enabled when both of values within a same index are larger than 1. In other words, the “number of slots for TBoMS” is valid and the “numberOfReotition” is invalid.

TABLE 1
TDRA table for both single slot
repetition and TBoMS transmission

| | | | | Number |
|---|---|---|---|---|
| | Mapping | | | of slots |
| Index | type | SLIV | numberOfRepetitions | for TBoMS |
| Index = 0 | Type A/B | Value A | One of value in a set | M (>=1) |
| . . . | Type A/B | Value B | One of value in a set | . . . |
| Index = N | TypeA/B | Value C | One of value in a set | M′ (>=1) |

Here, the set of value for numberOfRepetitions include both Rel 15/16 and Rel 17.

Method 2: Reuse the numberOfRepetitions in the Rel-15/16 TDRA list to indicate the number of slots for TBoMS.

The numberOfRepetitions in the TDRA list can be reused to indicate the number of slots for TBoMS, and a new signaling is needed to indicate whether the value in numberOfRepetitions is applicable for a single slot repetition transmission or TBoMS transmission or both. In some embodiments, when the repetition transmission for TBoMS is not supported, 1 bit signaling is sufficient (includes 2 states), and “0” or “1” is used to indicate a single slot repetition transmission and “1” or “0” is used to indicate a TBoMS transmission and the number of slots for TBoMS is equal to numberOfRepetitions. In some embodiments, when a repetition transmission for TBoMS is supported, 2-bit signaling with 4 states may be used. In this case, “00” indicates a single slot repetition, “01” indicates a TBoMS transmission, “10 or 11” indicates a TBoMS transmission with repetition. When the repetition for TBoMS is enabled, the number of slots for TBoMS and the number of repetitions for TBoMS are same and equal to the numberOfRepetitions. Furthermore, the number of repetition for TBoMS is equal to the numberOfRepetitions in the TDRA list and the number of slots for TBoMS is equal to the semi-static configured value of RepK or pusch-aggregationFactor or the number slots for TBoMS is equal to the numberOfRepetitions in the TDRA list and the repetition number for TBoMS is equal to the value of semi-static configured RepK or pusch-aggregationFactor. In one example, the RepK is configured by IE ConfiguredGrantConfig in TS 38.331, and the pusch-aggregationFactor is configured by IE PUSCH-Config information element in TS 38.331.

In some embodiments, when the TDRA list or numberOfRepetitions or number of slots in the TDRA list is not configured, and when the TBoMS transmission is enabled, the number of slots for TBoMS is equal to the value of semi-static configured RepK or pusch-aggregationFactor. In one example, the RepK is configured by IE ConfiguredGrantConfig in TS 38.331, and the pusch-aggregationFactor is configured by IE PUSCH-Config information element in TS 38.331. In some embodiments, when the TDRA list or number of slots in the TDRA list is not configured, then the TBoMS transmission is disabled.

In some embodiments, the new signaling can be included in RRC, MAC-CE or DCI. For example, when the new signaling is included in RRC, a simple way is to introduce a new IE in the TDRA list as shown in Table 2 (the new signaling is denoted as “TBoMS enable” in Table 2).

TABLE 2
Reuse the numberOfRepetitions

| | Map- | | | |
|---|---|---|---|---|
| | ping | | | |
| | type | SLIV | numberOfRepetitions | TBoMS enable |
| Index = 0 | A/B | Value A | One of value in a set | 1 bit (0/1)or |
| | | | | 2 bit(00/01/10/11) |
| . . . | A/B | Value B | One of value in a set | 1 bit (0/1)or |
| | | | | 2 bit(00/01/10/11) |
| Index = N | A/B | Value C | One of value in a set | 1 bit (0/1)or |
| | | | | 2 bit(00/01/10/11) |

In some embodiments, the above methods are also used for Physical Uplink Control Channel (PUCCH), MSG3, Physical Downlink Shared Channel (PDSCH), Physical Downlink Control Channel (PDCCH) transmissions.

### Embodiment 2

In 3GPP RAN1 #105 e-meeting, a working assumption of transmission occasion for TBoMS (TOT) structure has been agreed and a TOT includes at least one slot or multiple consecutive physical slots for UL transmission. How to structure the time domain pattern for TBoMS based on TOTs need to be studied.

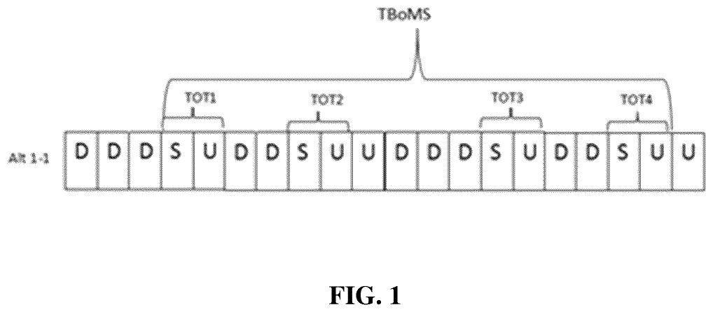

FIG. 1 shows an example of TBoMS time domain pattern based on a fixed indication length TOT.

In some embodiments, gNB indicates the length of TOT to UE via RRC, MAC CE or DCI (e.g., a field in DCI or length of TOT is configured in TDRA), each TOT has the same length within a TBoMS transmission. For instance, the frame structure is DDDSUDDSUU (where “S” slot can be used for TBoMS), the number of slots for TBoMS is 8 and available slots are used, and the length of TOT is 2 slots. By way of example, the TBoMS time domain pattern is shown in FIG. 1.

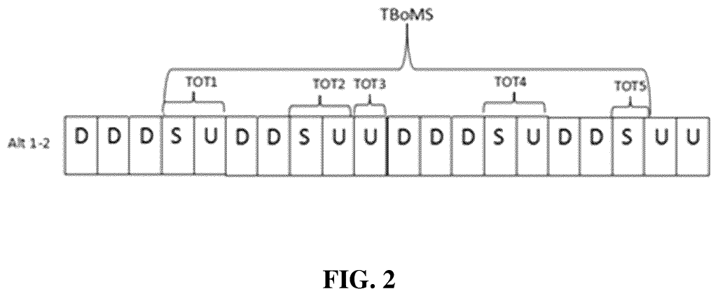

FIG. 2 shows an example of TBoMS time domain pattern based on a flexible length of TOT.

In some embodiments, gNB indicates the length of TOT to UE via RRC, MAC CE or DCI (e.g., a field in DCI or length of TOT is configured in TDRA), the time domain length of each TOT within a TBoMS does not need to be the same as each other (e.g., the time domain length of a TOT within a TBoMS is equal to or smaller than the indication value). For instance, the frame structure is DDDSUDDSUU (where “S” slot can be used for TBoMS), the number of slots for TBoMS is 8 and available slots are used, and the length of TOT is 2 slots. By way of example, the TBoMS time domain pattern is shown in FIG. 2.

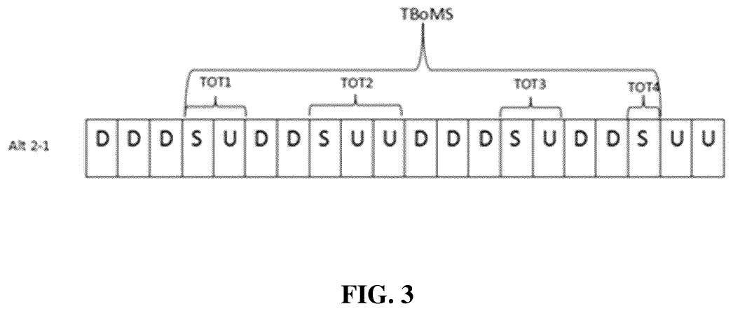

FIG. 3 shows an example of TBoMS time domain pattern based on flexible length of TOT.

In some embodiments, the time domain length of TOTs within TBoMS is not indicated and the time domain pattern for TBoMS is based on one or more TOTs and the number of slots in TDRA, the TOTs within a TBoMS may have different length. For instance, the frame structure is DDDSUDDSUU (where “S” slot can be used for TBoMS), the number of slots for TBoMS is 8 and available slots are used. By way of example, the TBoMS time domain pattern is shown in FIG. 3.

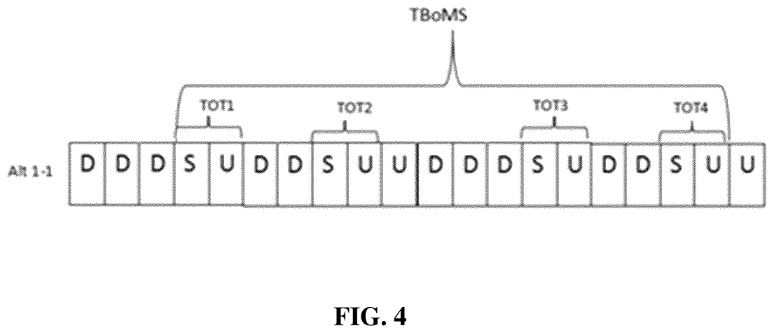

FIG. 4 shows an example of TBoMS time domain pattern is based on the length of first TOT.

In some embodiments, the time domain length of TOTs within TBoMS is not indicated and the time domain length of each TOT within TBoMS is the same and equal to the length of the first TOT. For instance, the frame structure is DDDSUDDSUU (where “S” slot can be used for TBoMS), the number of slots for TBoMS is 8 and available slots are used, the length of the first TOT is 2 slots. By way of example, the TBoMS time domain pattern is shown in FIG. 4.

In some embodiments, the time domain length of TOT within TBoMS is not indicated and the maximum time domain lengths of TOTs within TBoMS are not larger than the first TOT. For instance, the frame structure is DDDSUDDSUU (where “S” slot can be used for TBoMS), the number of slots for TBoMS is 8 and available slots are used, the length of first TOT is 2 slots. By way of example, the TBoMS time domain pattern is shown in FIG. 2.

In some embodiments, the above methods can also be used for PUCCH, MSG3, PDSCH, PDCCH transmissions.

### Embodiment 3

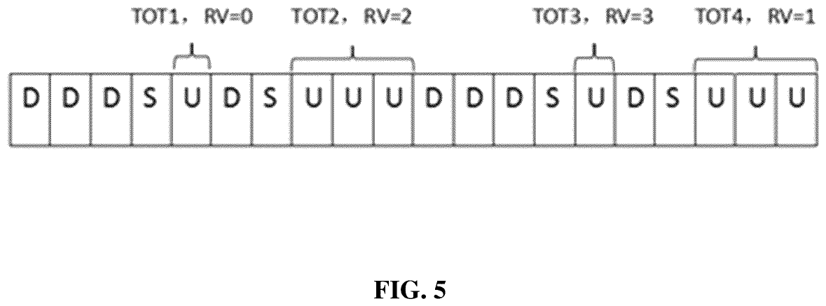

FIG. 5 shows an example of multiple RV cycling in TOTs.

When TB processing over multiple slots is enabled, a single RV (Redundancy Version) or multiple RVs are used for TBoMS need to be determined.

In some embodiments, multiple RVs cycling on multiple TOTs within TBoMS can be used, as shown in FIG. 5.

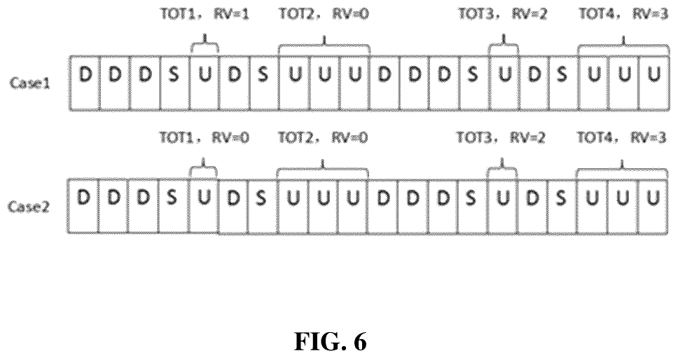

FIG. 6 shows new rules for RV cycling in TOTs.

In this case, if the code rate is higher than a threshold (e.g., 0.95 or 1 or other values), the systematic bits cannot be carried on the first TOT completely and the performance will be degraded. In some embodiments of the disclosed technology, a new RV cycling rule is provided to improve the performance. One method (Case 1) is implemented to change the RV cycling sequence and make RVO associated with the longest or the first time domain longest length of TOT within a TBoMS transmission. Another method (Case 2) is implemented to use RVO for all the TOTs from the first TOT to the longest time domain length TOT within the TBoMS transmission. FIG. 6 gives examples for these two cases. As shown in FIG. 6, four TOTs are used for TBoMS transmission and the length of each TOT is 1,3,1 and 3 slots respectively. Since the first TOT (denoted as TOT1 in FIG. 6) contains only one slot, the systematic bits may not be carried on the first TOT completely if traditional RV cycling, i.e., {0,2,3,1} is used over TOTs consecutively. Therefore, in Case 1, TOT2, the first longest TOT within the TBoMS transmission, is used for RVO instead. And in Case 2, RVO is transmitted over TOT1 and TOT2 (the first longest TOT within the TBoMS transmission), and the followed by RV2 on TOT3 and RV3 on TOT4 respectively.

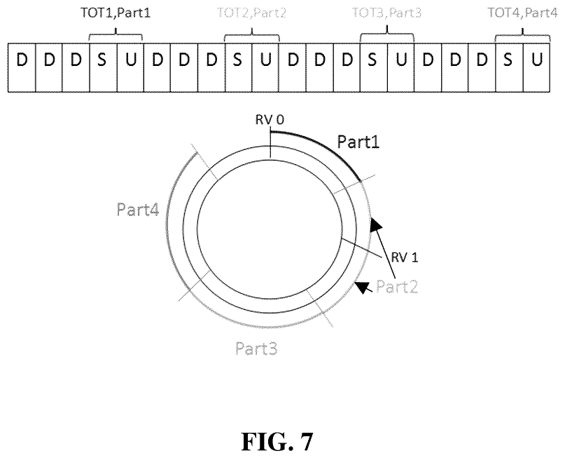

FIG. 7 shows an example of bits mapping for TOTs.

In some embodiments, if the collision handing of TBoMS is based on granularity of a TOT, in some cases, when some systematic bits are discarded due to collision (e.g. UL CI, overlapping with PUCCH, Synchronization Signal and PBCH block.SFI change the transmission direction of symbols or slots or other transmission with higher priority), then the performance will be degraded. One example is shown in FIG. 7.

Assuming TOT2 collides with other transmission and the part2 bits in circle buffer are discarded. The following method should be considered to solve the issue:

Method 1: When collision information is indicated to UE before the TBoMS PUSCH transmission, Re-rate matching should be performed if the timeline is satisfied. Where the timeline is a UE processing time for performing Re-rate matching.

Method 2: When the collision information is indicated to UE during the TBoMS PUSCH transmission, the coded bits should be consecutively mapped to the physical resource. For instance, as show in FIG. 7. when the TOT 2 is discarded due to collision, the part 1, Part 2, Part 3 coded bits in circle buffer are mapped to TOT1, TOT3 or TOT4 respectively.

In some embodiments, the above methods should also be used for PUCCH, MSG3, PDSCH, PDCCH transmission.

### Embodiment 4

When TB processing over multiple slots is enabled, and a UE transmits a PUCCH (PUCCHs) that overlaps with one or more TOTs within TBoMS PUSCH, the UCI information carried on PUCCH(s) would be multiplexed on PUSCH. In some implementations of the disclosed technology, the reference of timeline conditions for UCI multiplexing are determined. The timeline conditions for UCI multiplexing is defined in clause 9.2.5 of TS 38.213. The following methods are implemented based on this embodiment.

Option 1: The timeline is based on the first slot of overlapped TOT within TBoMS PUSCH

Option 2: The timeline is based on any one or more slots within the overlapped TOT of TBoMS PUSCH.

When the TB processing over multiple slots is enabled, and a UE transmits a PUCCH (PUCCHs) that overlaps with one or more TOTs within TBoMS PUSCH, the UCI information carried on PUCCH(s) can be multiplexed on TBoMS PUSCH. Then the number of coded modulation symbols for each layer of UCI information is determined based on some implementations of the disclosed technology. The UCI information includes at least one of the following and their combinations: HARQ-ACK, CSI part 1, CSI part 2, HARQ-ACK or CG-UCI. Take HARQ-ACK multiplexing on PUSCH as an example.

For HARQ-ACK transmission on PUSCH not using repetition type B with UL-SCH, the number of coded modulation symbols per layer for HARQ-ACK transmission, denoted as QA, is determined as follows:

$$\\ \begin{matrix}{Q}_{ACK}^{{}^{} ′} = min \{ ⌈ \frac{( {O}_{ACK} + {L}_{ACK} ) \cdot {β}_{offset}^{{}^{} PUSCH} \cdot {\sum }_{l = 0}^{{N}_{symb , all}^{{}^{} PUSCH} - 1} {M}_{sc}^{{}^{} UCI} ( l )}{{\sum }_{r = 0}^{{C}_{UL - SCH} - 1} {K}_{r}} ⌉ , ⌈ α \cdot {\sum }_{l = {l}_{0}}^{{N}_{symb , all}^{{}^{} PUSCH} - 1} {M}_{sc}^{{}^{} UCI} ( l ) ⌉ \} & ( Eq . 1 )\end{matrix}$$

### Where:

O_{ACK} is the number of HARQ-ACK bits;
if O_{ACK}≥360, L_{ACK}=11; otherwise L_{ACK} is the number of CRC bits for HARQ-ACK determined according to Clause 6.3.1.2.1 of TS38.212;
β_{offset}^{PUSCH}=β_{offset}^{HARQ-ACK};
C_{UL-SCH} is the number of code blocks for UL-SCH of the PUSCH transmission;
if the DCI format scheduling the PUSCH transmission includes a CBGTI field indicating that the UE shall not transmit the r-th code block, Kᵣ=0; otherwise, Kᵣ is the r-th code block size for UL-SCH of the PUSCH transmission;
M_{sc}^{PUSCH} is the scheduled bandwidth of the PUSCH transmission, expressed as a number of subcarriers;
M_{sc}^{PT-RS}(l) is the number of subcarriers in OFDM symbol l that carries PTRS, in the PUSCH transmission;
M_{sc}^{UCI}(l) is the number of resource elements that can be used for transmission of UCI in OFDM symbol l, for l=0,1,2, . . . , N_{symb,all}^{PUSCH}−1, in the PUSCH transmission and N_{symb,all}^{PUSCH} is the total number of OFDM symbols of the PUSCH, including all OFDM symbols used for DMRS;
   for any OFDM symbol that carries DMRS of the PUSCH, M_{sc}^{UCI}(l)=0;
   for any OFDM symbol that does not carry DMRS of the PUSCH, Mf (1)=ME-MN-RtS( )
α is configured by higher layer parameter scaling;
l₀ is the symbol index of the first OFDM symbol that does not carry DMRS of the PUSCH, after the first DMRS symbol(s), in the PUSCH transmission.

When TBoMS is enabled, the number of coded modulation symbols per layer for HARQ-ACK transmission in TBoMS can be calculated reusing Equation 1 above with one of the following modifications.

Option 1: C_{UL_SCH} is the number of code blocks for UL-SCH of the TBoMS PUSCH transmission. For

$$\\ {\sum }_{l = l 0}^{{N}_{symbol , all}^{{}^{} PUSCH} - 1} {M}_{sc}^{{}^{} UCI} ( l ) ,$$

N_{symb,all}^{PUSCH} is the total number of OFDM symbols of the PUSCH, including all OFDM symbols used for DMRS; For

$$\\ {\sum }_{l = l 0}^{{N}_{symbol , all}^{{}^{} PUSCH} - 1} {M}_{sc}^{{}^{} UCI} ( l ) ,$$

N_{symb,all}^{PUSCH} is redefined as the total number of OFDM symbols in one or more TOTs within TBoMS, including all OFDM symbols used for DMRS. In some embodiments, the one or more TOTs within TBoMS PUSCH that overlaps with the PUCCH.

Option 2: C_{UL-SCH} is redefined as the number of code blocks in one or more TOTs within TBoMS PUSCH transmission. In some embodiments, the number of C (code blocks) is equal to ceil([total number symbols (REs) of the one or more TOTs] divide [total number symbols(REs) of TBoMS]) or floor ([total number symbols(REs) of one or more TOTs] divide [total number symbols of TBoMS]), where the minimum number of C is equal to 1. Kᵣ is the r-th code block size for UL-SCH of the PUSCH transmission within the one or more TOTs. For

$$\\ {\sum }_{l = 0}^{{N}_{symb , all}^{{}^{} PUSCH} - 1} {M}_{sc}^{{}^{} UCI} ( l ) ,$$

N_{symb,all}^{PUSCH} is redefined as the total number of OFDM symbols in one or more TOTs within TBoMS PUSCH, including all OFDM symbols used for DMRS; For

$$\\ {\sum }_{l = l 0}^{{N}_{symbol , all}^{{}^{} PUSCH} - 1} {M}_{sc}^{{}^{} UCI} ( l ) ,$$

N_{symb,all}^{PUSCH} is redefined as the total number of OFDM symbols in one or more TOTs within TBoMS, including all OFDM symbols used for DMRS. In some embodiments, the one or more TOTs within TBoMS PUSCH that overlaps with the PUCCH.

Option 3: C_{UL-SCH} is the number of code blocks for UL-SCH of the TBoMS PUSCH transmission. Kᵣ is the r-th code block size for UL-SCH of the TBoMS PUSCH transmission. For

$$\\ {\sum }_{l = 0}^{{N}_{symb , all}^{{}^{} PUSCH} - 1} {M}_{sc}^{{}^{} UCI} ( l ) ,$$

N_{symb,all}^{PUSCH} is the total number of OFDM symbols in one or more TOTs within TBoMS PUSCH, including all OFDM symbols used for DMRS; In some embodiments,

$$\\ {\sum }_{r = 0}^{{C}_{UL - SCH} - 1} {K}_{r}$$

can be multiplied a factor K, where, K is smaller than 1. In some embodiments, the value of K is equal to:(Total number of symbols (REs) of the one or more TOTs) divide (Total number of symbols (REs) of the TBoMS). For

$$\\ {\sum }_{l = l 0}^{{N}_{symbol , all}^{{}^{} PUSCH} - 1} {M}_{sc}^{{}^{} UCI} ( l ) ,$$

N_{symb,all}^{PUSCH} is redefined as the total number of OFDM symbols in one or more TOTs within TBoMS, including all OFDM symbols used for DMRS. In some embodiments, the one or more TOTs within TBoMS PUSCH that overlaps with the PUCCH.

Option 4: C_{UL-SCH} is redefined as the number of code blocks in one or more TOTs within TBoMS PUSCH transmission. In some embodiments, the number of C (code blocks) is equal to ceil([total number symbols(REs) of the one or more TOTs] divide [total number symbols(REs) of TBoMS]) or floor ([total number symbols(REs) of one or more TOTs] divide [total number symbols of TBoMS]), where the minimum number of C is equal to 1. Kᵣ is the r-th code block size for UL-SCH of the TOT PUSCH transmission within TBoMS. For

$$\\ {\sum }_{l = 0}^{{N}_{symb , all}^{{}^{} PUSCH} - 1} {M}_{sc}^{{}^{} UCI} ( l ) ,$$

N_{symb,all}^{PUSCH} is redefined as the total number of OFDM symbols for TBoMS PUSCH, including all OFDM symbols used for DMRS. In some embodiments,

$$\\ {\sum }_{l = 0}^{{N}_{symb , all}^{{}^{} PUSCH} - 1} {M}_{sc}^{{}^{} UCI} ( l )$$

an be multiplied a factor k, where, k is smaller than 1. In some embodiments, the value of k is equal to:(Total number of symbols (REs) of the one or more TOTs) divide (Total number of symbols (REs) of the TBoMS). For

$$\\ {\sum }_{l = l 0}^{{N}_{symbol , all}^{{}^{} PUSCH} - 1} {M}_{sc}^{{}^{} UCI} ( l ) ,$$

N_{symb,all}^{PUSCH} is redefined as the total number of OFDM symbols in one or more TOTs within TBoMS, including all OFDM symbols used for DMRS. In some embodiments, the one or more TOTs within TBoMS PUSCH that overlaps with the PUCCH.

### Embodiment 5

In Rel-15/16, channel estimation is based on a single transmission occasion and a UE determines the PUSCH transmission power P_{PUSCH,b,f,c}(i,j,q_{d},l) in PUSCH transmission occasion i when a UE transmits a PUSCH on active UL BWP b of carrier f of serving cell c using parameter set configuration with index j and PUSCH power control adjustment state with index l by Equation 2 below.

$$\\ \begin{matrix}{P}_{PUSCH , b , f , c} ( i , j , {q}_{d} , l {}^{} ) = min \{ \begin{matrix}{P}_{CMAX , f , c} ( i ) , \\ {P}_{O \_ PUSCH , b , f , c} ( j ) + 10 {log}_{10} ( {2}^{μ} \cdot {M}_{RB , b , f , c}^{{}^{} PUSCH} ( i ) ) + {α}_{b , f , c} ( j ) \cdot {PL}_{b , f , c} ( {q}_{d} ) + {Δ}_{TF , b , f , c} ( i ) + {f}_{b , f , c} ( i , l {}^{} )\end{matrix} \} [ dBm ] & ( Eq . 2 )\end{matrix}$$

where:
P_{CMAX,f,c}(i) is the UE configured maximum output power for carrier f of serving cell c in PUSCH transmission occasion i;
P_{O_PUSCH,b,f,c}(j) is a parameter composed of the sum of a component P_{O_NOMINAL_PUSCH,f,c}(j) and a component P_{O_UE_PUSCH,b,f,c}(j) where j∈{0,1, . . . , J−1);
M_{RB,b,f,c}^{PUSCH}(i) is the bandwidth of the PUSCH resource assignment expressed in number of resource blocks for PUSCH transmission occasion i on active UL BWP b of carrier f of serving cell c and μ is a SCS configuration defined in [4, TS 38.211];
Δ_{TF,b,f,c}(i)=10 log₁₀((2^{BRPE·K}^{ₛ}−1)·β_{offset}^{PUSCH}) for K_{S}=1.25 and Δ_{TF,b,f,c}(i)=0 for K_{S}=0 is provided by deltaMCS for each UL BWP b of each carrier f and serving cell c. If the PUSCH transmission is over more than one layer [6, TS 38.214], Δ_{TF,b,f,c}(i)=0. BPRE and β_{offset}^{PUSCH}, for active UL BWP b of each carrier f and each serving cell C, are computed as below

$$\\ BPRE = {\sum }_{r = 0}^{C - 1} {K}_{r} / {N}_{RE}$$

for PUSCH with UL-SCH data and BPRE=Qₘ·R/β_{offset}^{PUSCH} for CSI transmission in a PUSCH without UL-SCH data, where
C is a number of transmitted code blocks, Kᵣ is a size for code block r, and N_{RE} is a number of resource elements determined as

$$\\ {N}_{RE} = {M}_{RB , b , f , c}^{{}^{} PUSCH} ( i ) \cdot {\sum }_{j = 0}^{{N}_{symb , b , f , c}^{{}^{} PUSCH} ( i ) - 1} {N}_{sc , data}^{{}^{} RB} ( i , j ) ,$$

where N_{symbb,f,c}(i) is a number of symbols for PUSCH transmission occasion i on active UL BWP b of carrier f of serving cell c, N_{sc,data}^{RB}(i,j) is a number of subcarriers excluding DM-RS subcarriers and phase-tracking RS samples [4, TS 38.211] in PUSCH symbol j and assuming no segmentation for a nominal repetition in case the PUSCH transmission is with repetition Type B, 0≤j<N_{symbb,f,c}^{PUSCH}(i), and C, Kᵣ are defined in [5, TS 38.212]
β_{offset}^{PUSCH}=1 when the PUSCH includes UL-SCH data and β_{offset}^{PUSCH}=β_{offset}^{CSI,1}, as described in Clause 9.3, when the PUSCH includes CSI and does not include UL-SCH data
Qₘ is the modulation order and R is the target code rate, as described in [6, TS 38.214], provided by the DCI format scheduling the PUSCH transmission that includes CSI and does not include UL-SCH data.

When TBoMS is enabled and a single TBoMS includes one or more TOTs, the power of TBoMS PUSCH transmission is determined based on some implementations of the disclosed technology. The current mechanism can be reused for TBoMS with small modifications. The N_{symbb,f,c}^{PUSCH}(i) is the number of symbols for TOT i within TBoMS PUSCH. Similarly, the number of code blocks is also based on the same TOT i. In some embodiments, C is the total number of code blocks for TBoMS,

$$\\ {\sum }_{r = 0}^{C - 1} {K}_{r}$$

is multiplied a factor k, where k is smaller than 1. Furthermore, in some embodiments, the k is equal to: (Total number of symbols (REs) of TOT i) divided by (Total number of symbols (REs) of the TBoMS). In some embodiments, the number of code blocks C is equal to ceil ([total number symbols(REs) of the one or more TOTs] divided by [total number symbols(REs) of TBoMS]) or floor ([total number symbols(REs) of one or more TOTs] divided by [total number of symbols of TBoMS]), where the minimum number of C is equal to 1.

### Embodiment 6

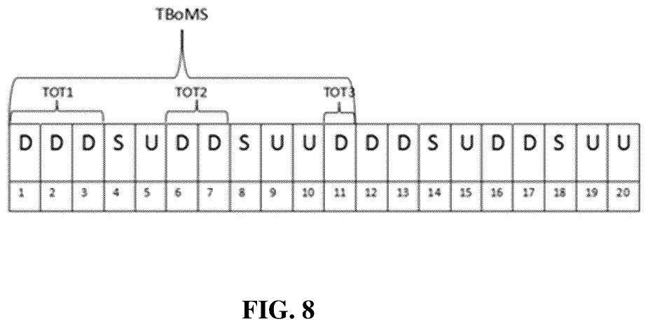

FIG. 8 shows an example where a feedback occasion is configured based on TOT.

In Rel-17, TBoMS for PUSCH transmission is introduced to improve the coverage performance of cell-edge UEs, and the main motivation for TBoMS is to improve the coverage capability for cell-edge UEs by obtaining a low code rate with a less number of RBs in the frequency domain, thereby boosting the PSD for cell-edge UE for better coverage. Similarly, the mechanism is also supported for downlink transmission (e.g., PDSCH, PDCCH). In Rel-15/16, UE can feed back HARQ-ACK for a TB until the last symbol of PDSCH transmission (with or without repetition) has been receive and only a single timeline (PDSCH-to-HARQ ACK timing) and PUCCH resource are configured to a UE. In a situation where TBoMS PDSCH transmission is enabled, if the mechanism in Rel-15/16 is to be used, the HARQ-ACK for a TB can only be fed back at the end of TBoMS PDSCH transmission even through a UE decodes the TB correctly during the PDSCH transmission, thus wasting some resources. Furthermore, when TBoMS PDSCH transmission based on CBG, multiple HARQ-ACK bits transmitted on a PUCCH resource may decrease the coverage performance. Thus, to improve the system resource efficiency and HARQ-ACK transmission coverage performance, the disclosed technology can be implemented in some embodiments to provide enhanced methods. In an implementation, multiple HARQ-ACK feedback occasions (it includes timeline and PUCCH resource) for a single TB transmission can be introduced. Here, the HARQ-ACK feedback occasion is used to transmit HARQ-ACK for a TB. In some embodiments, a TBoMS PDSCH transmission with a small TBS and a TB can include a CB. As shown in FIG. 8, TDD frame structure with “DDDSUDDSUU” can be taken as an example. A TBoMS PDSCH transmission includes 3 TOTs, and each TOT includes one or more consecutive physical slots for DL transmission. A feedback occasion can be configured for each of TOT. Then, UE can feed back the HARQ-ACK for the TB on multiple feedback occasions, e.g., a total of 3 HARQ-ACK feedback occasions are configured, and the first feedback occasion is on 5th slot and the second feedback occasion is on 10th slot and the third feedback occasion is on 14th slot (assuming S slot can be used for PUCCH transmission). The number of PUCCH resource and the timeline (PDSCH-to-HARQ-feedback timing) of each feedback occasion are configurable. In some embodiments, the feedback occasion is configured based on one or more TOTs. In some embodiments, the feedback occasion is configured based on one or more repetitions of TBoMS transmission. In some embodiments, the feedback occasion is configured based on a type A/B repetition or multiple type A/B repetitions. In some embodiments, the feedback occasion is configured based on one or more symbols. In some embodiments, the feedback occasion is configured based on one or more slots.

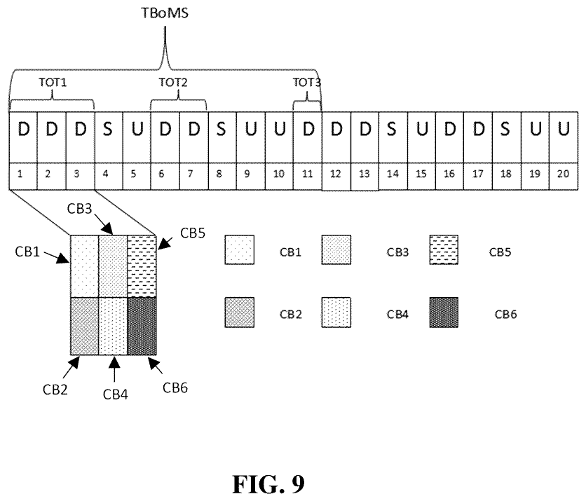

FIG. 9 shows an example where a feedback occasion is configured based on code block group (CBG).

In some embodiments, a TBoMS PDSCH transmission with a large TBS and a TB is includes multiple CBs. As shown in FIG. 9, TDD frame structure with “DDDSUDDSUU” can be taken as an example, and CBG transmission mechanism is assumed. UE can feed back the HARQ-ACK for each one or more CBGs on multiple feedback occasions. For instance, a TBoMS PDSCH TB is segmented into 12 CBs, and grouped into 6CBG, each CBG includes 2CBs (e.g., CBG1 includes CB1 and CB2, similar for other CBGs). A total of 3 feedback occasions are configured, and the first feedback occasion for {CBG1,CBG2,CBG3} HARQ-ACK feedback is on 5th slot and the second feedback occasion for {CBG4,CBG5} HARQ-ACK feedback is on 10th slot and the third feedback occasion for {CBG6} HARQ-ACK feedback is on 14th slots (Assuming S slot can be used for PUCCH transmission). Where, the UE can transmit HARQ-ACK for CBG(s) on feedback occasions. The number of PUCCH resource and the timeline for each feedback occasion are configurable.

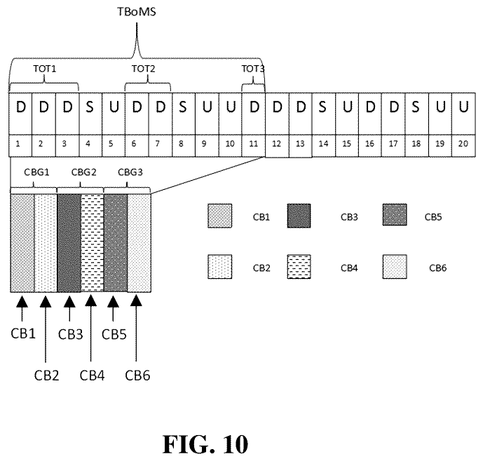

FIG. 10 shows feedback HARQ-ACK bits based on CBG.

In some embodiments, when the number of CBGs are not integer within a set of TOTs/slots, then ceil (number of CBG within the set of TOTs/slots) HARQ-ACK bits for the set of TOTs/slots are transmitted on the corresponding feedback occasion, and the remain parts of CBG (equal to: number of CBG within the set of TOTs/slots subtract ceil (number of CBG within the set of TOTs/slots)) is counted to the next set of TOTs/slots. Here, a set of TOTs/slots include at least a TOT/slot. For instance, as shown in FIG. 10, a TBoMS PDSCH TB is segmented into 6 CBs and grouped into 3 CBGs. A total of 3 feedback occasions are configured, and the first feedback occasion is on 5th slot and the second feedback occasion is on 10th slot and the third feedback occasion is on 14th slot (assuming S slot can be used for PUCCH transmission). Here, the UE can transmit HARQ-ACK for TB on the feedback occasion, and the number of PUCCH resource and the timeline for each feedback occasion are configurable. TOT1 includes CBG1 and part of CBG2(1.5 CBGs); TOT2 includes part of CBG2 and part of CBG3 (1 CBG); TOT3 includes part of CBG3(0.5 CBG). The HARQ-ACK bits for CBG1(ceil(1.5)CBGs) is transmitted on the first feedback occasion, the HARQ-ACK bits for CBG2(ceil(0.5+1)CBGs) is transmitted on the second feedback occasion, and the HARQ-ACK bits for CBG3(ceil(0.5+0.5)CBGs) is transmitted on the third feedback occasion.

In Rel-15/16, only a timeline (PDSCH-to-HARQ ACK timing) and PUCCH resource are configured for a UE to feed back HARQ-ACK of PDSCH transmission. To improve the resource efficient and HARQ feedback coverage performance, the disclosed technology can be implemented based on some embodiments to provide an enhanced method that configures multiple timelines and PUCCH resource for a UE as discussed below.

Method 1: A new field are introduced in DCI to indicate multiple timelines and PUCCH resources for UE HARQ-ACK transmissions. Taking DCI format 1-1 as an example, and assuming the “PUCCH resource indicator” field is 3 bits and “PDSCH-to-HARQ_feedback timing indicator” field is 3 bits (0, 1, 2, or 3 bits as defined in Clause 9.2.3 of [TS 38.2131), if two PUCCH resources and corresponding timelines are configured to UE, then (1) the “PUCCH resource indicator” field is 6 bits, and the highest 3 bits indicate the first PUCCH resource and the lowest 3 bits indicate the second PUCCH resource, and (2) the “PDSCH-to-HARQ feedback timing indicator” field is 6 bits, the highest 3 bits indicate the corresponding timeline of first PUCCH resource and the lowest 3 bits indicate the corresponding timeline of second PUCCH resource. In some embodiments, if the “PDSCH-to-HARQ feedback timing indicator” field is absent, the default timeline value should be used for all PUCCH resources.

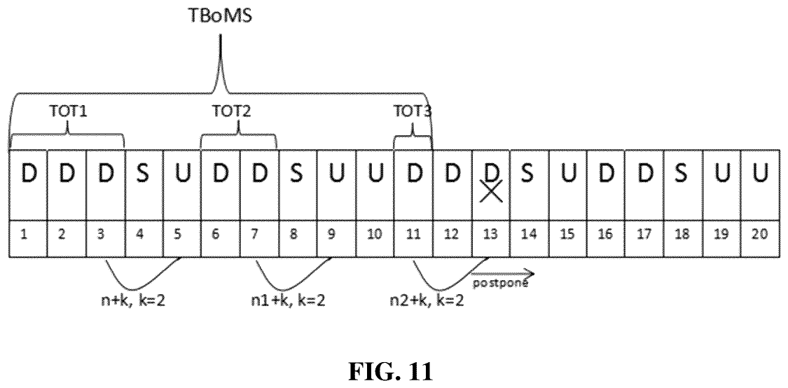

FIG. 11 shows an example of HARQ-ACK feedback occasions based on a first TOT.

Method 2: The timeline and PUCCH resource are configured based on the first TOT, then the timeline and PUCCH resources for each of the remaining TOTs are the same as the first TOT. For instance, as shown in FIG. 11, the frame structure is “DDDSUDDSUU,” TBoMS PDSCH include 3 TOTs, UE feedback HARQ-ACK for a TB based on TOT, the timeline is indicated as 2 and the PUCCH resource is indicated as i (i is integer), then the timeline is 2 and PUCCH resource index is i for both TOT2 and TOT3's feedback occasions. In some embodiments, if the feedback occasion for a TOT that is obtained based on the first TOT is not available, then UE can postpone the HARQ-ACK feedback to the nearest one available slot. In some embodiments, the timeline and PUCCH resource may be configured based on the first TOT group, each group of TOT has a HARQ-ACK feedback occasion, where a TOT group includes at least one TOT, and the TOTs within a TOT group can be consecutive or non-consecutive (e.g., assuming TOT2 and TOT3 in FIG. 11 constitute TOT group2, then TOT2 and TOT3 is non-consecutive, similar definition is used for other cases). In some embodiments, the timeline and PUCCH resource may be configured based on first slot/symbol group, each group of slot/symbol has a HARQ-ACK feedback occasion, where, a slot/symbol group include at least one slot/symbol, the slots/symbols within a slot/symbols group can be consecutive or non-consecutive. In some embodiments, the timeline and PUCCH resource may be configured based on the first repetition group, each group of repetitions has a HARQ-ACK feedback occasion, where a repetition group include at least one repetition, the repetition within a repetition group can be consecutive or non-consecutive, the repetition can be a single slot/mini-slot repetition or a TBoMS repetition. In some embodiments, if the “PDSCH-to-HARQ feedback timing indicator” field is absent, the default timeline value should be used for all PUCCH resources.

Method 3: Introducing signals to configure timelines and PUCCH resources table respectively, the “PUCCH resource indicator” and “PDSCH-to-HARQ_feedback timing indicator” fields in DCI can be reused to indicate an index of timelines table and an index of PUCCH resources table respectively. Where, each row of timeline table includes a set values of timeline and each row of PUCCH resources table includes a set of indices of PUCCH resource. The timeline table and PUCCH resource table are shown in table 3 and table 4 respectively, where N, M, Ti, and Pi are integers. For instance, if the field of “PUCCH resource indicator” and “PDSCH-to-HARQ_feedback timing indicator” in DCI are indicated as “1” and “1” respectively, then total 3 feedback occasion could be obtained, the timeline and PUCCH resource index of the first feedback occasion is {1,1}, the timeline and PUCCH resource index of the second feedback occasion is {2,2}, the timeline and PUCCH resource index of the third feedback occasion is {3,4}. In some embodiments, the number of timelines which are indicated by the field of “PDSCH-to-HARQ_feedback timing indicator” is the same as the number of PUCCH resources which are indicated by the field of “PUCCH resource indicator.” In some embodiments, the number of timelines indicated by the field of “PDSCH-to-HARQ_feedback timing indicator” can be different from the number of PUCCH resources indicated by the field of “PUCCH resource indicator,” In this case, at least one of the number of timelines and PUCCH resources index should be equal to 1. Then, the total feedback occasion number is larger than 1. In some embodiments, if the “PDSCH-to-HARQ feedback timing indicator” field is absent, the default timeline value should be used for all PUCCH resources.

TABLE 3
timeline table

| Index | Timeline value |
|---|---|
| 1 | 1, 2, 3 |
| . . . | . . . |
| N | a set of Tᵢ (Tᵢ is integer) |

TABLE 4
PUCCH resources table

| Index | PUCCH resource index |
|---|---|
| 1 | 1, 2, 4 |
| . . . | . . . |
| M | a set of Pᵢ(Pᵢ is integer) |

In some embodiments, the timeline and PUCCH resource indices can be combined coding, introducing a signal to indicate the table of timeline and PUCCH resource index, as shown in Table 5. Then the field of “PUCCH resource indicator” and “PDSCH-to-HARQ_feedback timing indicator” can be connected to each other, indicating an index of the table. In some embodiments, the number of timelines and PUCCH resources index is the same within a row. In some embodiments, the number of timelines and PUCCH resources index is different within a row. In this case, at least one of the number of timelines and PUCCH resource index is equal to 1. In some embodiments, if the “PDSCH-to-HARQ feedback timing indicator” field is absent, the default timeline value should be used for all PUCCH resources.

TABLE 5
timeline and PUCCH resources combined coding

| Index | Timelines | PUCCH resources index |
|---|---|---|
| 1 | 1, 2, 3 | 1, 2, 3 |
| 2 | 4 | 4, 5, 6 |
| 3 | 5, 6 | 7 |
| . . . | . . . | . . . |
| L | a set of Tᵢ (Tᵢ is integer) | a set of Tᵢ (Tᵢ is integer) |

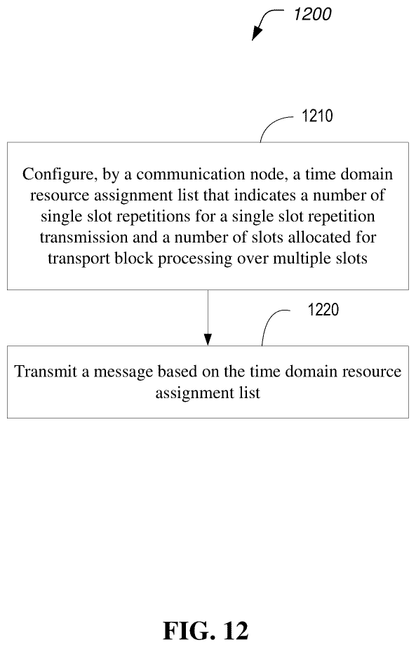

FIG. 12 shows an example of a wireless communication method based on some embodiments of the disclosed technology.

In some embodiments of the disclosed technology, a wireless communication method 1200 includes, at 1210, configuring, by a communication node, a time domain resource assignment list that indicates a number of single slot repetitions for a single slot repetition transmission and a number of slots allocated for transport block processing over multiple slots, and at 1220, transmitting a message based on the time domain resource assignment list. The time domain resource assignment list includes the TDRA list discussed above. The transport block processing over multiple slots includes TBoMS discussed above.

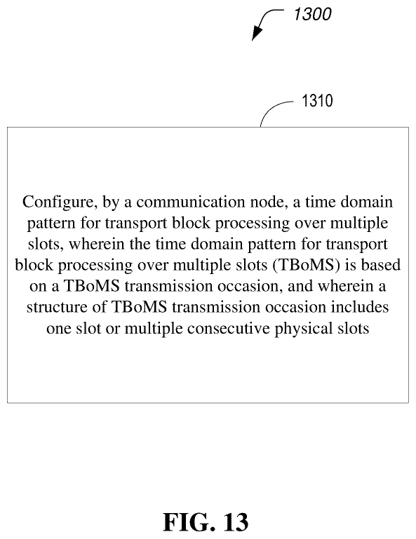

FIG. 13 shows another example of a wireless communication method based on some embodiments of the disclosed technology.

In some embodiments of the disclosed technology, a wireless communication method 1300 includes, at 1310, configuring, by a communication node, a time domain pattern for transport block processing over multiple slots, wherein the time domain pattern for transport block processing over multiple slots (TBoMS) is based on a TBoMS transmission occasion, and wherein a structure of TBoMS transmission occasion includes one slot or multiple consecutive physical slots.

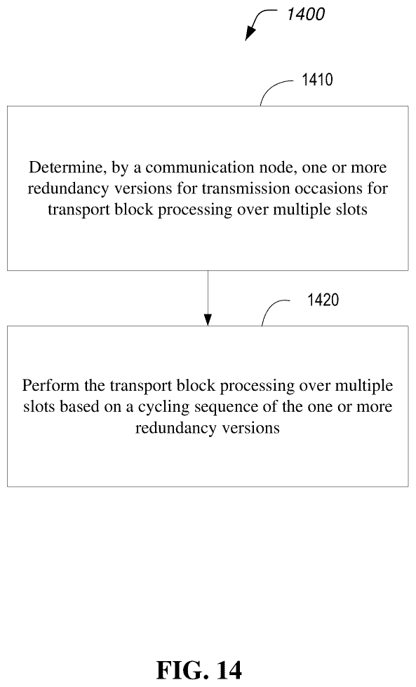

FIG. 14 shows another example of a wireless communication method based on some embodiments of the disclosed technology.

In some embodiments of the disclosed technology, a wireless communication method 1400 includes, at 1410, determining, by a communication node, one or more redundancy versions for transmission occasions for transport block processing over multiple slots, and at 1420, performing the transport block processing over multiple slots based on a cycling sequence of the one or more redundancy versions.

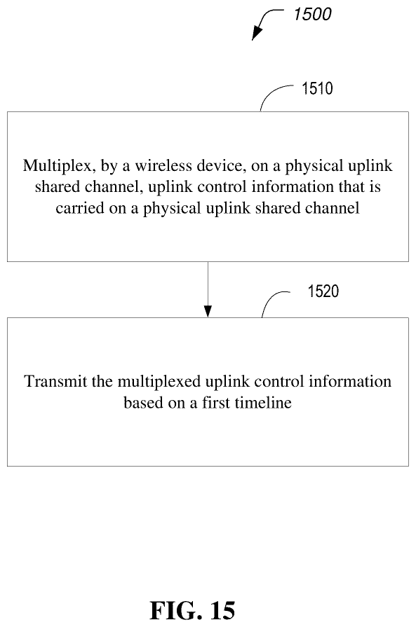

FIG. 15 shows another example of a wireless communication method based on some embodiments of the disclosed technology.

In some embodiments of the disclosed technology, a wireless communication method 1500 includes, at 1510, multiplexing, by a wireless device, on a physical uplink shared channel, uplink control information that is carried on a physical uplink shared channel, and at 1520, transmitting the multiplexed uplink control information based on a first timeline.

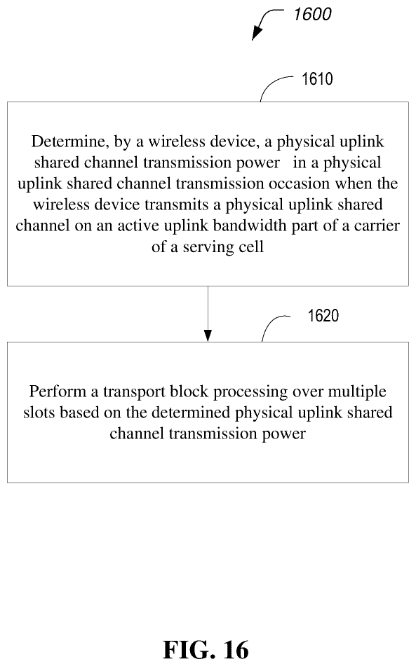

FIG. 16 shows another example of a wireless communication method based on some embodiments of the disclosed technology.

In some embodiments of the disclosed technology, a wireless communication method 1600 includes, at 1610, determining, by a wireless device, a physical uplink shared channel transmission power in a physical uplink shared channel transmission occasion when the wireless device transmits a physical uplink shared channel on an active uplink bandwidth part of a carrier of a serving cell, and at 1620, performing a transport block processing over multiple slots based on the determined physical uplink shared channel transmission power.

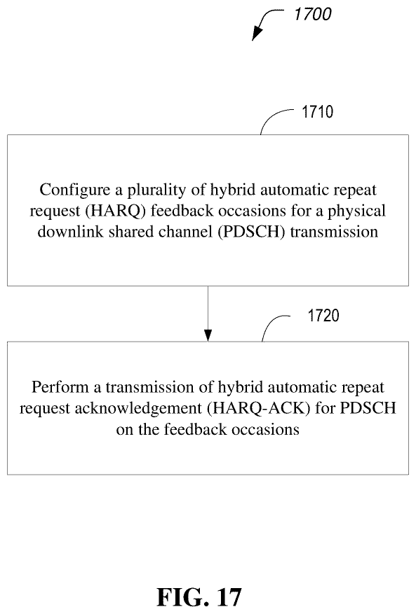

FIG. 17 shows another example of a wireless communication method based on some embodiments of the disclosed technology.

In some embodiments of the disclosed technology, a wireless communication method 1700 includes, at 1710, configuring a plurality of hybrid automatic repeat request (HARQ) feedback occasions for a physical downlink shared channel (PDSCH) transmission, and at 1720, performing a transmission of hybrid automatic repeat request acknowledgement (HARQ-ACK) for PDSCH on the feedback occasions.

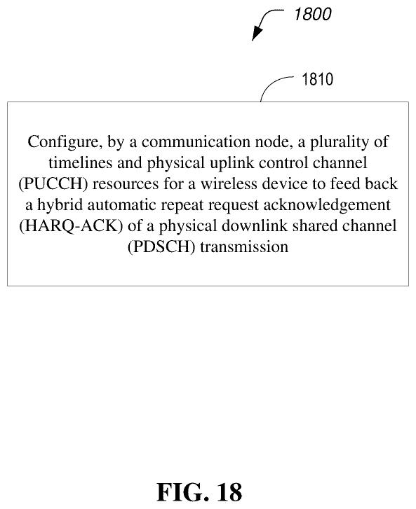

FIG. 18 shows another example of a wireless communication method based on some embodiments of the disclosed technology.

In some embodiments of the disclosed technology, a wireless communication method 1800 includes, at 1810, configuring, by a communication node, a plurality of timelines and physical uplink control channel (PUCCH) resources for a wireless device to feed back a hybrid automatic repeat request acknowledgement (HARQ-ACK) of a physical downlink shared channel (PDSCH) transmission.

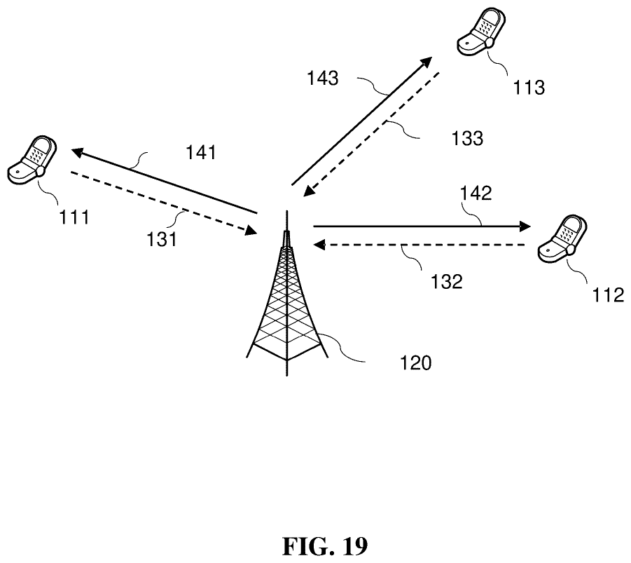

FIG. 19 shows an example of a wireless communication system (e.g., an LTE, 5G New Radio (NR) cellular network) that includes a radio access node 120 and one or more user equipment (UE) 111, 112 and 113. In some embodiments, the downlink transmissions (141, 142, 143) include a control plane message that comprises a processing order for processing the plurality of user plane functions. This may be followed by uplink transmissions (131, 132, 133) based on the processing order received by the UEs. Similarly, the user plane functions can be processed by UEs for downlink transmissions based on the processing order received. The UE may be, for example, a smartphone, a tablet, a mobile computer, a machine to machine (M2M) device, a terminal, a mobile device, an Internet of Things (IoT) device, and so on.

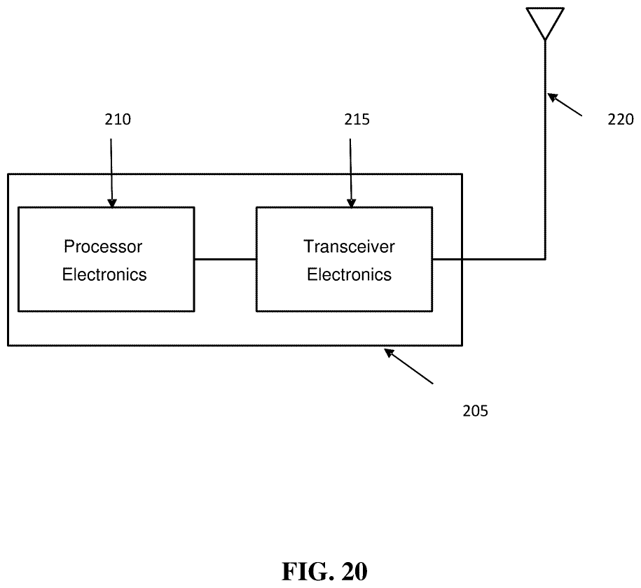

FIG. 20 is a block diagram representation of a portion of a radio station based on one or more embodiments of the disclosed technology can be applied. A radio station 205 such as a base station or a wireless device (or UE) can include processor electronics 210 such as a microprocessor that implements one or more of the wireless techniques presented in this document. The radio station 205 can include transceiver electronics 215 to send and/or receive wireless signals over one or more communication interfaces such as antenna 220. The radio station 205 can include other communication interfaces for transmitting and receiving data. Radio station 205 can include one or more memories (not explicitly shown) configured to store information such as data and/or instructions. In some implementations, the processor electronics 210 can include at least a portion of the transceiver electronics 215. In some embodiments, at least some of the disclosed techniques, modules or functions are implemented using the radio station 205.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

Some embodiments may preferably implement one or more of the following solutions, listed in clause-format. The following clauses are supported and further described in the Examples above and throughout this document. As used in the clauses below and in the claims, a wireless terminal may be user equipment, mobile station, or any other wireless terminal including fixed nodes such as base stations. A network node includes a base station including a next generation Node B (gNB), enhanced Node B (eNB), or any other device that performs as a base station. A resource range may refer to a range of time-frequency resources or blocks.

Clause 1. A method for wireless communication, comprising: configuring, by a communication node, a time domain resource assignment list that indicates a number of single slot repetitions for a single slot repetition transmission and a number of slots allocated for transport block processing over multiple slots; and transmitting a message based on the time domain resource assignment list.

Clause 2. The method of clause 1, wherein the time domain resource assignment list includes a first column that includes a first value to indicate the number of slots allocated for transport block processing over multiple slots, and wherein the transport block processing over multiple slots is enabled in a case that the first value is larger than a first threshold value.

Clause 3. The method of clause 1, wherein the number of single slot repetitions and the number of slots allocated for transport block processing over multiple slots is not larger than 1 simultaneously within a same index.

Clause 4. The method of clause 2, wherein the time domain resource assignment list includes a second column that includes a second value to indicate the number of single slot repetitions, and wherein the transport block processing over multiple slots is disabled and the single slot repetition transmission is enabled in a case that the second value is larger than a second threshold value.

Clause 5. The method of clause 2, wherein the time domain resource assignment list includes a second column that includes a second value to indicate the number of single slot repetitions, and wherein a repetition of the transport block processing over multiple slots is enabled in a case that the first value and the second value are larger than the first threshold value and a second threshold value, respectively.

Clause 6. The method of clause 1, wherein a radio resource control (RRC) signaling or a medium access control element (MAC-CE) is used to indicate whether the transport block processing over multiple slots or the single slot repetition transmission or the repetition of transport block processing over multiple slots is enabled.

Clause 7. The method of clause 1, wherein a bit field in downlink control information (DCI) is used to indicate whether the transport block processing over multiple slots or the single slot repetition transmission or the repetition of transport block processing over multiple slots is enabled.

Clause 8. The method of clause 1, wherein the time domain resource assignment list includes a second column that includes a second value to indicate the number of single slot repetitions, and wherein the second value further indicates as the number of slots allocated for transport block processing over multiple slots.

Clause 9. The method of clause 1, wherein the time domain resource assignment list includes a second column that includes a multi-bit value to indicate whether the second column indicates: the number of single slot repetitions; the number of slots allocated for transport block processing over multiple slots; or both the number of slots allocated for transport block processing over multiple slots and repetitions.

Clause 10. The method of any of clauses 1-9, wherein, in a case that the time domain resource assignment list is not configured, or the first column or the second column are not configured, the number of slots allocated for transport block processing over multiple slots is determined based on a value of semi-statically configured RepK or pusch-aggregationFactor.

Clause 11. A method for wireless communication, comprising: configuring, by a communication node, a time domain pattern for transport block processing over multiple slots, wherein the time domain pattern for transport block processing over multiple slots (TBoMS) is based on a TBoMS transmission occasion, and wherein a structure of TBoMS transmission occasion includes one slot or multiple consecutive physical slots.

Clause 12. The method of clause 11, wherein the communication node transmits an indication for a length of the transmission occasion for transport block processing over multiple slots, to a wireless device, using a radio resource control (RRC) signaling, a medium access control element (MAC-CE), or downlink control information (DCI).

Clause 13. The method of clause 11, wherein each of the TBoMS transmission occasions has an identical length within a transmission based on the transport block processing over multiple slots.

Clause 14. The method of clause 11, wherein at least one of the transmission occasions has different length from other transmission occasions within a transmission based on the transport block processing over multiple slots.

Clause 15. The method of clause 11, wherein the length of the TBoMS transmission occasion within a transport block processing over a multiple-slot transmission is identical to a length of the first TBoMS transmission occasion.

Clause 16. A method for wireless communication, comprising: determining, by a communication node, one or more redundancy versions for transmission occasions for transport block processing over multiple slots; and performing the transport block processing over multiple slots based on a cycling sequence of the one or more redundancy versions.

Clause 17. The method of clause 16, further comprising, in a case that a code rate is higher than a threshold value, changing the cycling sequence of the one or more redundancy versions, wherein the redundancy versions for a transport block processing over multiple slots (TBoMS) transmission occasion are RV 0, and wherein a transmission occasion has a longest time domain length.

Clause 18. The method of clause 16, further comprising, in a case that a code rate is higher than a threshold value, changing the cycling sequence of the one or more redundancy versions, wherein the redundancy versions for a set of TBoMS transmission occasions are RV 0, and wherein a set of transmission occasions for TBoMS (TOTs) includes all the TOTs between a first TOT and a TOT that has a longest time domain length.

Clause 19. The method of clause 16, further comprising, in a case that the transmission occasions for transport block processing over multiple slots collide with another transmission, performing a coding bits mapping.

Clause 20. The method of clause 19, wherein, in a case collision information is transmitted to a wireless device before the transmission of TBoMS and satisfy a timeline, performing a re-rate matching.

Clause 21. The method of clause 19, wherein, in a case collision information is transmitted to a wireless device during the transmission of transport block processing over multiple slots, consecutively mapping coded bits to physical resources.

Clause 22. A method for wireless communication, comprising: multiplexing, by a wireless device, on a physical uplink shared channel, uplink control information that is carried on a physical uplink shared channel; and transmitting the multiplexed uplink control information based on a first timeline.

Clause 23. The method of clause 22, wherein the first timeline is based on a first slot of overlapped transmission occasions for transport block processing over multiple slots within a physical uplink shared channel.

Clause 24. The method of clause 22, wherein the first timeline is based on one or more slots within overlapped transmission occasions for transport block processing over multiple slots.

Clause 25. A method for wireless communication, comprising: determining, by a wireless device, a physical uplink shared channel transmission power in a physical uplink shared channel transmission occasion when the wireless device transmits a physical uplink shared channel on an active uplink bandwidth part of a carrier of a serving cell; and performing a transport block processing over multiple slots based on the determined physical uplink shared channel transmission power.

Clause 26. The method of clause 25, wherein a number of symbols is determined based on a TOT within the transport block processing over multiple slots PUSCH.

Clause 27. The method of clause 25, wherein a number of code blocks is determined based on a TOT within the transport block processing over multiple slots PUSCH.

Clause 28. A method for wireless communication, comprising: configuring a plurality of hybrid automatic repeat request (HARQ) feedback occasions for a physical downlink shared channel (PDSCH) transmission; and performing a transmission of hybrid automatic repeat request acknowledgement (HARQ-ACK) for PDSCH on the feedback occasions.

Clause 29. The method of clause 28, wherein the PDSCH transmission is a TBoMS PDSCH transmission and includes one or more TOTs, and wherein each of the TOTs includes one or more consecutive physical slots.

Clause 30. The method of clause 29, wherein the HARQ feedback occasions are configured based on one or more TOTs, or one or more repetitions.

Clause 31. A method for wireless communication, comprising: configuring, by a communication node, a plurality of timelines and physical uplink control channel (PUCCH) resources for a wireless device to feed back a hybrid automatic repeat request acknowledgement (HARQ-ACK) of a physical downlink shared channel (PDSCH) transmission.

Clause 32. The method of clause 31, wherein the configuring of the plurality of timelines and PUCCH resources includes indicating the plurality of timelines and PUCCH resources in downlink control information (DCI).

Clause 33. The method of clause 31, wherein the timelines and PUCCH resources are configured based on a first transmission occasion for transport block processing over multiple slots (TOT).

Clause 34. The method of 33, wherein the timelines and PUCCH resource for each remaining TOT within TBoMS PDSCH is identical to the timelines and PUCCH resource for the first TOT.

Clause 35. The method of clause 31, wherein the configuring of the plurality of timelines and PUCCH resources includes transmitting a first signal that is used to configure the timelines and a second signal that is used to configure the PUCCH resources.

Clause 36. The method of clause 35, wherein the first signal includes an index of timeline table, and the second signal includes an index of PUCCH resource table.

Clause 37. The method of clause 31, wherein the configuring of the plurality of timelines and PUCCH resources includes transmitting a signal that is used to configure the timelines and the PUCCH resources, wherein the signal includes an index of timelines and PUCCH resources table.

Clause 38. An apparatus for wireless communication, comprising a memory and a processor, wherein the processor reads code from the memory and implements a method recited in any of clauses 1 to 37.

Clause 39. A computer readable program storage medium having code stored thereon, the code, when executed by a processor, causing the processor to implement a method recited in any of clauses 1 to 37.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1.-39. (canceled)

40. A method for wireless communication, comprising:
configuring, by a communication node, a time domain resource assignment list that indicates a number of single slot repetitions for a single slot repetition transmission and a number of slots allocated for transport block processing over multiple slots; and
transmitting a message based on the time domain resource assignment list.

41. The method of claim 40, wherein the time domain resource assignment list includes a first column that includes a first value to indicate the number of slots allocated for transport block processing over multiple slots, and wherein the transport block processing over multiple slots is enabled in a case that the first value is larger than a first threshold value.

42. The method of claim 40, wherein the number of single slot repetitions and the number of slots allocated for transport block processing over multiple slots is not larger than 1 simultaneously within a same index.

43. The method of claim 41, wherein the time domain resource assignment list includes a second column that includes a second value to indicate the number of single slot repetitions, and wherein the transport block processing over multiple slots is disabled and the single slot repetition transmission is enabled in a case that the second value is larger than a second threshold value.

44. The method of claim 41, wherein the time domain resource assignment list includes a second column that includes a second value to indicate the number of single slot repetitions, and wherein a repetition of the transport block processing over multiple slots is enabled in a case that the first value and the second value are larger than the first threshold value and a second threshold value, respectively.

45. The method of claim 40, wherein a radio resource control (RRC) signaling or a medium access control element (MAC-CE) is used to indicate whether the transport block processing over multiple slots or the single slot repetition transmission or the repetition of transport block processing over multiple slots is enabled.

46. The method of claim 40, wherein a bit field in downlink control information (DCI) is used to indicate whether the transport block processing over multiple slots or the single slot repetition transmission or the repetition of transport block processing over multiple slots is enabled.

47. The method of claim 40, wherein the time domain resource assignment list includes a second column that includes a second value to indicate the number of single slot repetitions, and wherein the second value further indicates as the number of slots allocated for transport block processing over multiple slots.

48. The method of claim 40, wherein the time domain resource assignment list includes a second column that includes a multi-bit value to indicate whether the second column indicates: the number of single slot repetitions; the number of slots allocated for transport block processing over multiple slots; or both the number of slots allocated for transport block processing over multiple slots and repetitions.

49. A method for wireless communication, comprising:
configuring, by a communication node, a time domain pattern for transport block processing over multiple slots, wherein the time domain pattern for transport block processing over multiple slots (TBoMS) is based on a TBoMS transmission occasion, and wherein a structure of TBoMS transmission occasion includes one slot or multiple consecutive physical slots.

50. The method of claim 49, wherein the communication node transmits an indication for a length of the transmission occasion for transport block processing over multiple slots, to a wireless device, using a radio resource control (RRC) signaling, a medium access control element (MAC-CE), or downlink control information (DCI).

51. The method of claim 49, wherein each of the TBoMS transmission occasions has an identical length within a transmission based on the transport block processing over multiple slots.

52. The method of claim 49, wherein at least one of the transmission occasions has different length from other transmission occasions within a transmission based on the transport block processing over multiple slots.

53. The method of claim 49, wherein a length of the TBoMS transmission occasion within a transport block processing over a multiple-slot transmission is identical to a length of a first TBoMS transmission occasion.

54. A method for wireless communication, comprising:
determining, by a communication node, one or more redundancy versions for transmission occasions for transport block processing over multiple slots; and
performing the transport block processing over multiple slots based on a cycling sequence of the one or more redundancy versions.

55. The method of claim 54, further comprising, in a case that a code rate is higher than a threshold value, changing the cycling sequence of the one or more redundancy versions, wherein the redundancy versions for a transport block processing over multiple slots (TBoMS) transmission occasion are redundancy version (RV) 0, and wherein a transmission occasion has a longest time domain length.

56. The method of claim 54, further comprising, in a case that a code rate is higher than a threshold value, changing the cycling sequence of the one or more redundancy versions, wherein the redundancy versions for a set of TBoMS transmission occasions are RV 0, and wherein a set of transmission occasions for TBoMS (TOTs) includes all the TOTs between a first TOT and a TOT that has a longest time domain length.

57. The method of claim 54, further comprising, in a case that the transmission occasions for transport block processing over multiple slots collide with another transmission, performing a coding bits mapping.

58. The method of claim 57, wherein, in a case collision information is transmitted to a wireless device before the transmission of TBoMS and satisfy a timeline, performing a re-rate matching.

59. The method of claim 57, wherein, in a case collision information is transmitted to a wireless device during the transmission of transport block processing over multiple slots, consecutively mapping coded bits to physical resources.
